(19) United States
(12) Patent Application Publication
(10) Pub. No.: US 2024/0339629 A1
(43) Pub. Date: Oct. 10, 2024

(54) PREPARATION OF A CATALYST INK FOR MANUFACTURING A CATALYST COATED MEMBRANE (CCM)

(71) Applicant: Temasek Polytechnic, Singapore (SG)

(72) Inventors: Mei Lin CHNG, Singapore (SG); Ming HAN, Singapore (SG); Lei WANG, Singapore (SG); Cheng Lam Jonathan CHUA, Singapore (SG); Lijun LIU, Singapore (SG)

(21) Appl. No.: 18/294,465

(22) PCT Filed: Aug. 2, 2022
(86) PCT No.: PCT/SG2022/050555

§ 371 Date: Feb. 1, 2024

(30) Foreign Application Priority Data
Aug. 2, 2021 (SG) 10202108416X

(51) Int. Cl. H01M 4/88; H01M 4/86; H01M 4/92; H01M 8/1004

(52) U.S. Cl. CPC H01M 4/8828; H01M 4/8668; H01M 4/925; H01M 8/1004

(57) ABSTRACT

The invention relates to a process for the preparation of a catalyst ink formulation, said process comprising the steps of: (i) providing a mixture comprising a catalyst, an ionomer and water that has been subjected to ball milling; and (ii) subjecting the mixture to an ultrasonication step for a time period of from about 1 minute to about 1 hour.

### FIELD OF THE INVENTION

The invention relates to processes for the preparation of catalyst ink formulations that are useful in catalyst coated membranes.

### BACKGROUND

Catalyst coated membranes (CCMs) are critical stack components in fuel cells. The CCM facilitates electrochemical conversion of fuel to electrical energy. CCMs typically comprise a proton exchange membrane in electrical contact with each of the electrodes (namely the anode and cathode). CCMs typically utilize precious metal catalysts and permit diffusion of the reactants to the electrodes.

CCMs are typically very expensive due to the precious metal catalysts, and so a key problem associated with fuel cell commercialization is high cost.

There are two main commercial processes for the preparation of CCMs.
(a) Transfer of electrocatalyst layers via a flexible substrate to the membrane surface.
(b) Direct spray deposition where the catalyst layers are directly sprayed on the membrane surface.

Transfer of electrocatalyst layers via a flexible substrate to the membrane surface involves multiple steps. US20110217621A1 describes a process for forming a catalyst-coated membrane via a roll to roll manufacturing method in which the electrocatalyst layers are transferred via a flexible substrate to the membrane surface. However, this involves many complex steps and the tedious process of coating the electrocatalyst on the substrate first before transferring it to the membrane, leading to high cost. U.S. Pat. No. 5,234,777 relates to a method for forming a catalyst layer directly on a proton conductive membrane by a decal process whereby a catalytic layer composition is coated on a support and then peeled off to obtain a thin catalyst film. The catalyst film is pressed onto the surface of a proton exchange membrane to form a complete catalytic layer. However, disadvantages of using the decal transfer method include poor dispersion of catalyst particles and catalyst degradation during this hot pressing process. Defects such as cracking may occur during the transfer and peeling step, leading to catalyst loss during transfer onto the membrane (i.e. not all catalyst being transferred to the membrane).

The direct spray deposition process simplified the steps involved by coating the catalyst layers directly on the membrane surface. US Patent Application No. 20080206616A1 and U.S. Pat. No. 6,221,523 B1 adopt a direct spray deposition process in which the catalyst layers are directly applied to the membrane. The process required multiple stacked catalyst layers to be formed directly on the membrane through alternating spraying and vaporizing steps. The multiple layers are formed from multiple inks, comprising catalyst particles having different average particle sizes. A disadvantage with this process is the requirement for multiple inks results in a high wastage of catalyst, as well as agglomerisation and nozzle blockage during the spraying process. The approach is also time-consuming since many different spraying steps are required, and the different inks may result in defects between catalyst layers or other structural issues.

There is therefore a need for an efficient process for preparing catalyst ink formulations that may easily be applied to a membrane by a spray deposition process, thereby forming a CCM without high wastage.

### SUMMARY OF THE INVENTION

The inventors have surprisingly found that the problems associated with the prior art are overcome by the processes described herein. In particular, the processes of the invention enable the preparation of a homogeneous catalyst ink formulation that may be directly applied to membranes by spray coating to form a homogeneous catalyst coating on a CCM. The inks produced according to the invention also reduce the chance of nozzle blockage during spray coating.

The invention therefore provides the following.
1. A process for the preparation of a catalyst ink formulation, said process comprising the steps of:
(i) providing a mixture comprising a catalyst, an ionomer and water that has been subjected to ball milling; and
(ii) subjecting the mixture to an ultrasonication step for a time period of from about 1 minute to about 1 hour.
2. The process according to Clause 1, wherein the mixture comprising a catalyst, an ionomer and water that has been subjected to ball milling is obtained by the steps of:
(a) providing a mixture comprising a catalyst, an ionomer and water;
(b) subjecting the mixture to a ball milling step for a time period of from about 1 to about 20 minutes; and
(c) filtering the milled mixture.
3. The process according to Clause 2, wherein before step (ii) the filtered mixture from step (c) is diluted with an organic diluent that is selected from the group consisting of a C₁₋₄ alcohol and mixtures thereof,
   optionally wherein the organic diluent is selected from the group consisting of propan-1-ol and propan-2-ol,
   optionally wherein the weight ratio of organic diluent to catalyst is from about 3:1 to about 10:1.
4. The process according to any one of the preceding clauses, wherein the mixture in step (i) further comprises an organic solvent,
   optionally wherein the organic solvent comprises an alcohol,
   more optionally wherein the organic solvent comprises one or more selected from the group consisting of ethanol, propan-1-ol and propan-2-ol.
5. The process according to Clause 4, wherein the mixture comprising a catalyst, an ionomer and water has a ratio X:Y of from about 1:3 to about 1:15, wherein
   X is the total mass of catalyst, inclusive of any solid support, and ionomer; and
   Y is the total mass of water and when present, organic diluent and/or organic solvent, optionally wherein the ratio X:Y is from about 1:5 to about 1:10.
6. The process according to Clause 2, or according to any one of Clauses 3 to 5 as dependent on Clause 2, wherein the mixture comprising a catalyst, an ionomer and water has a solids content of from 3 to 30 wt. %, optionally from 5 to 20 wt. %.
7. The process according to any one of the preceding clauses, wherein the catalyst is selected from the group consisting of platinum, ruthenium, osmium, platinum-ruthenium alloy, platinum-osmium alloy, platinum-palladium alloy, platinum-M alloy and a combination thereof, wherein M is a transition metal selected from a group consisting of Ga, Ti, V, Cr, Mn, Fe, Co, Ni, Cu, Zn, Sn, Mo, W, Rh and a combination thereof,
   optionally wherein the catalyst is selected from the group consisting of platinum, platinum-ruthenium alloy, platinum-osmium alloy, platinum-palladium alloy, platinum-M alloy and a combination thereof, wherein M is a transition metal selected from a group consisting of Ga, Ti, V, Cr, Mn, Fe, Co, Ni, Cu, Zn, Sn, Mo, W, Rh and a combination thereof, more optionally wherein the catalyst is platinum.
8. The process according to any one of the preceding clauses, wherein the catalyst is provided on a solid support,
   optionally wherein the solid support is a carbon support.
9. The process according to any one of the preceding clauses, wherein the ionomer comprises a perfluorinated polymer,
   optionally wherein the ionomer comprises sulfonated tetrafluoroethylene based fluoropolymer-copolymer.
10. The process according to any one of the preceding clauses, wherein the weight ratio of catalyst, inclusive of any solid support, to ionomer in the mixture in step (i) is from about 1:1 to about 5:1, optionally from about 1.5:1 to about 4:1.
11. The process according to any one of the preceding clauses, wherein the weight ratio of catalyst, inclusive of any solid support, to water in the mixture in step (i) is from about 1:2 to about 1:5, optionally from about 1:2 to about 1:3.
12. The process according to Clause 2 or any one of Clauses 3 to 11 as dependent upon Clause 2, wherein the ball milling step is performed using Zirconia balls,
   optionally wherein the Zirconia balls have an average diameter of from about 2 to about 8 mm, such as about 5 mm.
13. The process according to Clause 2 or any one of Clauses 3 to 12 as dependent upon Clause 2, wherein the ball milling step is performed using a planetary ball mill.
14. The process according to Clause 2 or any one of Clauses 3 to 13 as dependent upon Clause 2, wherein the ball milling step is performed at a rotation speed of from about 100 rpm to about 500 rpm,
   optionally from about 200 rpm to about 400 rpm,
   more optionally from about 250 rpm to about 350 rpm.
15. The process according to any one of the preceding clauses, wherein the ball milling step is performed for a time period of from about 3 to about 15 minutes,
optionally for a time period of from about 4 to about 10 minutes.
16. The process according to Clause 2 or any one of Clauses 3 to 15 as dependent upon Clause 2, wherein the filtering step is performed using a filter having a pore size of from about 20 to about 100 microns,
   optionally a pore size of from about 30 to about 45 microns.
17. The process according to any one of the preceding clauses, wherein the ultrasonication step is performed for a time period of from about 10 minutes to about 40 minutes,
   optionally from about 15 minutes to about 30 minutes.
18. The process according to any one of the preceding clauses, wherein the ultrasonication step is performed at a frequency of from about 20 kHz to about 30 KHz.
19. The process according to any one of the preceding clauses, further comprising a step:
(iii) spray coating the catalyst ink formulation onto a membrane.
20. The process according to Clause 19, further comprising a step:
(iv) incorporating the catalyst coated membrane into a fuel cell.
21. A process of forming a catalyst coated membrane, comprising the steps:
(A) providing a catalyst ink formulation comprising a catalyst, an ionomer and water that has been subjected to ball milling followed by ultrasonication; and
(B) spray coating the catalyst ink formulation onto a membrane.
22. The process according to Clause 21, wherein the catalyst ink formulation is prepared by a method according to any one of Clauses 1 to 18.
23. The process according to Clause 21 or 22, further comprising a step:
(C) incorporating the catalyst coated membrane into a fuel cell.

### BRIEF DESCRIPTION OF THE FIGURES

FIG. 1 shows a chart contrasting the power and voltage of a fuel cell prepared using a catalyst ink prepared according to the invention, and one prepared by traditional methods.

FIG. 2 shows the effect of the length of a ball milling step on the consistency of a catalyst ink formulation.

### DETAILED DESCRIPTION OF THE INVENTION

Catalyst ink formulations typically comprise an ionomer (a proton-conducting polymer), a catalyst, and one or more solvents.

Examples of suitable ionomers include perfluorinated polymers, such as sulfonated perfluorinated polymers, e.g. sulfonated tetrafluoroethylene based fluoropolymer-copolymer.

Examples of suitable catalyst include platinum, ruthenium, osmium, platinum-ruthenium alloy, platinum-osmium alloy, platinum-palladium alloy, platinum-M alloy and combinations thereof,
where M is a transition metal selected from a group consisting of Ga, Ti, V, Cr, Mn, Fe, Co, Ni, Cu, Zn, Sn, Mo, W, Rh and combinations thereof.

Examples of suitable solvents useful in catalyst ink formulations include water, organic solvents and mixtures thereof. Suitable organic solvents may be miscible with water, for example the organic solvent may be an alcohol, such as a C₁₋₄ alcohol or mixtures thereof. Examples of specific organic solvents that may be used in catalyst ink formulations include ethanol, propan-1-ol and propan-2-ol.

While catalyst ink formulations are typically prepared by mixing the above components together and conducting processing steps to homogenize the formulation, the inventors have surprisingly found that an improved formulation having advantageously high homogeneity may be obtained by controlling the specific ordering of the steps.

Thus, the inventors have found that an improved catalyst ink formulation may be obtained by the following general method.
1. Preparing a mixture comprising ionomer, catalyst, and solvent (e.g. water and/or organic solvent) having a controlled viscosity/ratio of solid:liquid components
2. Subjecting the mixture to a short ball milling step.
3. Filtering the mixture and diluting it with an organic diluent.
4. Sonicating the diluted mixture.
5. Spray coating the sonicated mixture.

In particular, the inventors have surprisingly found that the use of ball milling before dilution and sonication results in a catalyst ink formulation that has excellent homogeneity and results in an excellent catalyst coated membrane after spray coating. Fuel cells incorporating such catalyst coated membranes have improved performance, as shown in the Examples. These benefits are not obtained when ball milling and sonication are not used in this precise order, or if the mixture is not diluted with organic diluent before sonication.

If the mixture is not diluted before sonication, then the formulation used for spray coating will be too viscous for efficient spray coating. If the mixture is diluted only after sonication, and before spray coating, then it will not have the required homogeneity. However, if a more diluted mixture is used for steps 1 and 2, then the ball milling will not result in effective dispersion of the solid components, because ball milling is most effective for a highly viscous mixture with a low amount of liquid.

Therefore, the specific ordering of the steps set out above is believed to result in a more advantageous method and a catalyst ink formulation that enables more facile spray coating to produce catalyst coated membranes with a more efficient process and reduced catalyst loss.

In accordance with the above, the invention provides a process for the preparation of a catalyst ink formulation, said process comprising the steps of:
(i) providing a mixture comprising a catalyst, an ionomer and water that has been subjected to ball milling; and
(ii) subjecting the mixture to an ultrasonication step for a time period of from about 1 minute to about 1 hour.

The word “comprising” refers herein may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a composition” includes mixtures of two or more such compositions, reference to “an oxygen carrier” includes mixtures of two or more such oxygen carriers, reference to “the catalyst” includes mixtures of two or more such catalysts, and the like.

As defined in the IUPAC Gold Book, a catalyst a species that increases the rate of a reaction without modifying the overall standard Gibbs energy change in the reaction. When the term “catalyst” is used herein it refers to a catalyst that is able to catalyse the breakdown of a fuel used by a fuel cell into components including protons and electrons, which are used by the fuel cell to generate a current.

In some embodiments of the invention that may be mentioned herein, the catalyst may comprise one or more selected from the group consisting of platinum, ruthenium, osmium, platinum-ruthenium alloy, platinum-osmium alloy, platinum-palladium alloy, platinum-M alloy and a combination thereof, wherein M is a transition metal selected from a group consisting of Ga, Ti, V, Cr, Mn, Fe, Co, Ni, Cu, Zn, Sn, Mo, W, Rh and a combination thereof.

In some embodiments of the invention that may be mentioned herein, the catalyst may comprise one or more selected from the group consisting of platinum, platinum-ruthenium alloy, platinum-osmium alloy, platinum-palladium alloy, platinum-M alloy and a combination thereof, wherein M is a transition metal selected from a group consisting of Ga, Ti, V, Cr, Mn, Fe, Co, Ni, Cu, Zn, Sn, Mo, W, Rh and a combination thereof.

In some embodiments of the invention that may be mentioned herein, the catalyst may comprise platinum.

In some embodiments of the invention that may be mentioned herein, the catalyst may be provided on a solid support. This may be particularly advantageous when the solid support has a high surface area. An example of a suitable solid support that may be mentioned herein is carbon.

As used herein, the term “ionomer” refers to a polymer composed of macromolecules in which a proportion of the constitutional units has ionic or ionizable groups, or both. For the avoidance of doubt, the term “ionomer” as used herein refers to a polymer, and does not include any solvents in which an ionomer may be provided as part of a commercially available formulation.

In some embodiments of the invention that may be mentioned herein, the ionomer may comprise a perfluorinated polymer. In some embodiments of the invention that may be mentioned herein, the ionomer may comprise a sulfonated perfluorinated polymer, e.g. a sulfonated tetrafluoroethylene based fluoropolymer-copolymer.

The mixture in step (i) of the invention comprises water. In some embodiments of the invention that may be mentioned herein, the water may be deionised water, for example deionised water having a resistivity of greater than 18MΩ·cm at 25° C.

In some embodiments of the invention that may be mentioned herein, the mixture comprising a catalyst, an ionomer and water that has been subjected to ball milling may be obtained by the steps of:
(a) providing a mixture comprising a catalyst, an ionomer and water;
(b) subjecting the mixture to a ball milling step for a time period of from about 1 to about 20 minutes; and
(c) filtering the milled mixture.

The use of a short ball milling time (1 to 20 minutes) reduces the production time of the catalyst ink, thereby reducing cost in a commercial context. In addition, the use of traditional ball milling processes (1 to 24 hours) often results in degradation and separation of the materials in the catalyst ink formulation. The use of a shorter ball milling time is therefore highly advantageous, as shown in the Examples.

In some embodiments of the invention that may be mentioned herein, before step (ii) the filtered mixture from step (c) may be diluted with an organic diluent, such as a C₁₋₄ alcohol (e.g. propan-1-ol or propan-2-ol). The weight ratio of the organic diluent (e.g. C₁₋₄ alcohol) to catalyst may be from about 3:1 to about 10:1. Without being bound by theory, it is believed that this weight ratio may result in a viscosity that allows for effective spray coating.

In some embodiments of the invention that may be mentioned herein, the mixture in step (i) may further comprise an organic solvent. This may be desirable to improve the solubility of the ionomer. The organic solvent may be miscible with water, and may comprise an alcohol (e.g. a C₁₋₄ alcohol). Specific examples of suitable organic solvents for this purpose include one or more organic solvents selected from the group consisting of ethanol, propan-1-ol and propan-2-ol.

In some embodiments of the invention that may be mentioned herein, the mixture comprising a catalyst, an ionomer and water may have a ratio X:Y of from about 1:3 to about 1:15, wherein
X is the total mass of catalyst, inclusive of any solid support, and ionomer; and
Y is the total mass of water and when present, organic diluent and/or organic solvent,

In some embodiments of the invention that may be mentioned herein, the ratio X:Y may be from about 1:5 to about 1:10.

Without being bound by theory, it is believed that these ratios result in a mixture having an appropriate viscosity for effective ball milling. This ensures that large agglomerates are broken down, and the ionomer is evenly distributed on the catalyst.

Therefore, in some embodiments of the invention that may be mentioned herein, the mixture comprising a catalyst, an ionomer and water may have a solids content of from 3 to 30 wt. %, for example from 5 to 20 wt. %. These weight percent ranges are believed to result in an appropriate viscosity for ball milling. For the avoidance of doubt, the term “solids” as used herein in this context does not include materials that are present as a solute, even if such materials would otherwise exist in the solid state under standard temperature and pressure. In other words, when the ionomer is present in the mixture while dissolved in solution, it is not considered a “solid” for the purposes of this parameter.

In some embodiments of the invention that may be mentioned herein, the weight ratio of catalyst, inclusive of any solid support, to ionomer in the mixture in step (i) may be from about 1:1 to about 5:1, for example from about 1.5:1 to about 4:1.

In some embodiments of the invention that may be mentioned herein, the weight ratio of catalyst, inclusive of any solid support, to water in the mixture in step (i) may be from about 1:2 to about 1:5, for example from about 1:2 to about 1:3.

In some embodiments of the invention that may be mentioned herein, the ball milling step may be performed using any appropriate apparatus, e.g. a planetary ball mill.

In some embodiments of the invention that may be mentioned herein, the ball milling step may be performed at a rotation speed of from about 100 rpm to about 500 rpm, such as from about 200 rpm to about 400 rpm, for example from about 250 rpm to about 350 rpm.

In some embodiments of the invention that may be mentioned herein, the ball milling step may be performed for a time period of from about 3 to about 15 minutes, such as a time period of from about 4 to about 10 minutes.

In some embodiments of the invention that may be mentioned herein, the ball milling step may be performed using zirconia balls and/or a zirconia grinding bowl. The balls used in the ball milling step may have any appropriate diameter. In some embodiments of the invention that may be mentioned herein, the ball milling balls (e.g. zirconia balls) may have an average diameter of from about 2 to about 8 mm, such as about 5 mm.

In some embodiments of the invention that may be mentioned herein, the filtering step may be performed using a filter having a pore size of from about 20 to about 100 microns, such as a pore size of from about 30 to about 45 microns. A specific example of a filter that may be used in the invention is a 400 mesh filter.

In some embodiments of the invention that may be mentioned herein, the ultrasonication step may be performed for a time period of from about 10 minutes to about 40 minutes, such as from about 15 minutes to about 30 minutes.

In some embodiments of the invention that may be mentioned herein, the ultrasonication step may be performed at a frequency of from about 20 kHz to about 30 kHz, e.g. about 25 KHz.

As discussed herein, the catalyst ink formulations may be used to form a catalyst coated membrane. Thus, the invention provides a process as described herein further comprising a step:

(iii) spray coating the catalyst ink formulation onto a membrane.

The spray coating step may comprise spraying multiple coats on each side of the membrane. The number of coats may be calculated based on the loading of catalyst required [which differs for the cathode side (e.g. 0.4 mg/cm²) and anode side (e.g. 0.1 mg/cm²)]. The spraying process may be stopped after achieving the desired catalyst loading, based on a theoretical calculation based on the weight difference before and after spray coating.

By way of example, if a desired loading is 0.2 mg/cm², and a single spray cycle of 3 mL ink on a 20×20 cm membrane achieves 0.1 mg/cm² catalyst loading, then one additional spray cycle will be performed.

The catalyst coated membrane may be useful in a fuel cell. Thus, the invention also provides a process further comprising a step:
(iv) incorporating the catalyst coated membrane into a fuel cell.

Similarly, the invention also provides a process of forming a catalyst coated membrane, comprising the steps:
(A) providing a catalyst ink formulation comprising a catalyst, an ionomer and water that has been subjected to ball milling followed by ultrasonication; and
(B) spray coating the catalyst ink formulation onto a membrane.

The catalyst ink formulation used in this process may be prepared by a method as defined herein.

The process may further comprise a step of:
(C) incorporating the catalyst coated membrane into a fuel cell.

The invention is illustrated by the below Examples, which are not to be construed as limitative.

### EXAMPLES

### General Preparation Method 1

1. 6.25 g of catalyst powder may be weighed and dispersed in 15 g of deionized water and placed into a 250 ml Zirconia grinding bowl.
2. 5 mm Zirconia balls and 50 g of Nafion solution (5% by weight) may be added into the Zirconia grinding bowl. The grinding bowl may be covered with an air-tight sealing cover.
3. Ball milling may be carried out via a planetary ball mill PM 100 at room temperature with a rotation speed of 300 rpm for 5 min (total time of 10 min inclusive of a 1 min interval).
4. After the ball milling process is completed, the ink mixture may be filtered through a 400-mesh filter.
5. 30 g of isopropanol may be added to the filtered ink mixture.
6. The filtered ink mixture may be placed in a sonicator (25 kHz) at room temperature for 15 min to produce a homogenous catalyst ink with the desired viscosity.
7. The obtained ink mixture may be transferred into an ultrasonic syringe holder and primed for at least ½ hour to maintain the suspension and homogeneity of the catalyst power particles before spray coating.

Spray coating may be performed using standard methods known in the art. For example, the spray coating step may comprise spraying multiple coats on each side of the membrane using a Sono-tek XYZ motion ultrasonic coating systems (Model: ExactaCoat). The number of coats may be calculated based on the loading of catalyst required [which differs for the cathode size (e.g. 0.4 mg/cm²) and anode side (e.g. 0.1 mg/cm²)]. The spraying process may be stopped after achieving the desired catalyst loading, based on a theoretical calculation based on the weight difference before and after spray coating. By way of example, if a desired loading is 0.2 mg/cm², and a single spray cycle of 3 mL ink on a 20×20 cm membrane achieves 0.1 mg/cm² catalyst loading, then one additional spray cycle will be performed.

### Example 1: Ink Formulation for a Non-Humidified System

This example describes an ink formulation for the manufacture of a CCM useful in a non-humidified system (open-cathode). Such a formulation may comprise a higher percentage of ionomer.

Based on a desired ionomer weight percentage of 40% (compared to catalyst powder), an ink mixture was prepared by following General Preparation Method 1 using 6.25 g of catalyst powder (Tanaka TEC10V40E, 40 wt. % Pt/C), 4.17 g of Nafion resin (79.61 g Chemours D520, 5% Nafion by weight) and 15 g deionized water. Ball milling was conducted for 10 min at 300 rpm. The ink mixture was filtered through a 400 mesh filter before 30 g of isopropanol was added to the filtered ink mixture. Sonication was performed at room temperature for 15 min using an Elma Multi-frequency ultrasonic unit (Model: TI-H-10) at 25 KHz.

The catalyst (C)/ionomer (I) weight ratio in the ink was 1.5:1 (i.e. 6.25:4.17).

The ink was applied onto a membrane substrate by spray coating using a Sono-tek XYZ motion ultrasonic coating systems (Model: ExactaCoat).

### Example 2: Ink Formulation for a Humidified System

This example describes an ink formulation for the manufacture of a CCM useful in a humidified system (closed-cathode). Such a formulation may comprise a lower percentage of ionomer.

Based on a desired ionomer weight percentage of 20% (compared to catalyst powder), an ink mixture was prepared by following General Preparation Method 1 using 6.25 g of catalyst powder (Tanaka TEC10V40E, 40 wt. % Pt/C), 1.56 g of Nafion resin (29.64 g Chemours D520, 5% Nafion by weight) and 15 g deionized water. Ball milling was conducted for 10 min at 300 rpm. The ink mixture was filtered through a 400 mesh filter before 30 g of isopropanol was added to the filtered ink mixture. Sonication was performed at room temperature for 15 min using an Elma Multi-frequency ultrasonic unit (Model: TI-H-10) at 25 KHz.

The catalyst (C)/ionomer (I) weight ratio in the ink was 4:1 (i.e. 6.25:1.56).

The ink was applied onto a membrane substrate by spray coating using a Sono-tek XYZ motion ultrasonic coating systems (Model: ExactaCoat).

The invention solves many of the problems associated with the prior art by producing a homogenous catalyst formulation that may be used directly in spray coating. In particular, the invention overcomes the problems of agglomeration of catalyst and nozzle blockage during spray coating.

### Example 3: Comparison of Process Step Order

Two ink formulations were prepared by the method of Example 1 except that for one formulation the isopropanol from step 5 of General Preparation Method 1 was instead added at an earlier stage, before ball milling. This resulted in a more dilute four component mixture during the ball milling step (catalyst, ionomer solution, isopropanol and water). The ink formulation prepared by this method will subsequently be referred to as the “four component” ink formulation.

The other formulation was prepared according to Example 1, and will subsequently be referred to as the “three component” ink formulation.

The two catalyst ink formulations (“three component” and “four component”) were both incorporated in fuel cells as described below.

Fuel cells were prepared as follows. The catalyst ink formulations were sprayed onto the membrane substrate by the ultrasonic coating system (ExactaCoat) to achieve similar catalyst loadings for both formulations with an effective area of 8 cm². Membrane electrode assembly was fabricated from the anode-membrane-cathode sandwich and a 5-cell stack was assembled to conduct the PEMFC tests via an in-house Fuel Cell Test System. The air-cooled open-cathode PEMFC stack consist of 5 cells in series with an active area of 8 cm². The open structure of the cathode flow field was used to supply ambient air to the fuel cell while also removing heat and water.

TABLE A
Properties of the fuel cell stack.

| Power output | 0-15 | W |
|---|---|---|
| Current output | 0-5 | A |
| Operating voltage | 1-5 | V |
| Operating temperature | 0-65° | C. |
| Cell number | 5 | |
| Active electrode area | 8 | cm² |
| Hydrogen inlet pressure | 1 | bar |

| | |
|---|---|
| Hydrogen purity | 99.999% |

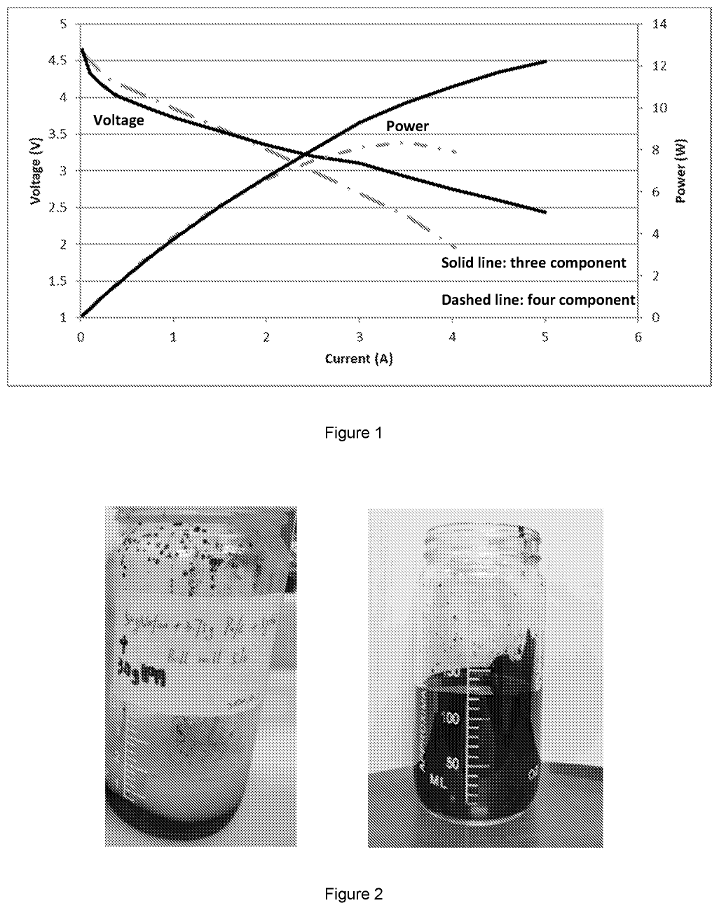

Polarization curves were generated for the 5-cell stack made using a CCM coated with each of the formulations (FIG. 1).
The 5-cell stack made using the “four component” ink formulation in which isopropanol was included in step 1 had decreased performance. This is believed to be because the mixture subjected to ball milling was too dilute to result in complete homogenisation.
In contrast, the 5-cell stack made using the “three component” ink formulation (i.e. prepared according to Example 1) had excellent performance.

### Example 4: Comparison of Ball Milling Time

A traditional ball milling time of 5 hours causes an increase in temperature of the catalyst ink mixture, leading thermal degradation and depolymerisation of the ionomer during the high shear process. As shown in FIG. 2 (left), this resulted in the separation of the mixture.

In contrast, a shorter ball milling time of 10 minutes (with 1 min interval) maintained the mixture within a favourable temperature range while also providing the required reduction in particle size and even distribution of ionomer on carbon and Pt nanoparticles. This shorter ball milling time resulted in a highly homogeneous formulation as shown in FIG. 2 (right)

1. A process for the preparation of a catalyst ink formulation, said process comprising the steps of:
(i) providing a mixture comprising a catalyst, an ionomer and water that has been subjected to ball milling; and
(ii) subjecting the mixture to an ultrasonication step for a time period of from about 1 minute to about 1 hour.

2. The process according to claim 1, wherein the mixture comprising a catalyst, an ionomer and water that has been subjected to ball milling is obtained by the steps of:
(a) providing a mixture comprising a catalyst, an ionomer and water;
(b) subjecting the mixture to a ball milling step for a time period of from about 1 to about 20 minutes; and
(c) filtering the milled mixture.

3. The process according to claim 2, wherein before step (ii) the filtered mixture from step (c) is diluted with an organic diluent that is selected from the group consisting of a C₁₋₄ alcohol and mixtures thereof.

4. The process according to claim 1, wherein the mixture in step (i) further comprises an organic solvent.

5. The process according to claim 4, wherein the mixture comprising a catalyst, an ionomer and water has a ratio X:Y of from about 1:3 to about 1:15, wherein
X is the total mass of catalyst, inclusive of any solid support, and ionomer; and
Y is the total mass of water and when present, organic diluent and/or organic solvent.

6. The process according to claim 2, wherein the mixture comprising a catalyst, an ionomer and water has a solids content of from 3 to 30 wt. %.

7. The process according to claim 1, wherein the catalyst is selected from the group consisting of platinum, ruthenium, osmium, platinum-ruthenium alloy, platinum-osmium alloy, platinum-palladium alloy, platinum-M alloy and a combination thereof, wherein M is a transition metal selected from a group consisting of Ga, Ti, V, Cr, Mn, Fe, Co, Ni, Cu, Zn, Sn, Mo, W, Rh and a combination thereof.

8. The process according to claim 1, wherein the catalyst is provided on a solid support.

9. The process according to claim 1, wherein the ionomer comprises a perfluorinated polymer.

10. The process according to claim 1, wherein the weight ratio of catalyst, inclusive of any solid support, to ionomer in the mixture in step (i) is from about 1:1 to about 5:1.

11. The process according to claim 1, wherein the weight ratio of catalyst, inclusive of any solid support, to water in the mixture in step (i) is from about 1:2 to about 1:5.

12. The process according to claim 2, wherein the ball milling step is performed using Zirconia balls.

13. The process according to claim 2, wherein the ball milling step is performed using a planetary ball mill.

14. The process according to claim 2, wherein the ball milling step is performed at a rotation speed of from about 100 rpm to about 500 rpm.

15. The process according to claim 1, wherein the ball milling step is performed for a time period of from about 3 to about 15 minutes.

16. The process according to claim 2, wherein the filtering step is performed using a filter having a pore size of from about 20 to about 100 microns.

17. The process according to claim 1, wherein the ultrasonication step is performed for a time period of from about 10 minutes to about 40 minutes.

18. The process according to claim 1, wherein the ultrasonication step is performed at a frequency of from about 20 kHz to about 30 kHz.

19. The process according to claim 1, further comprising a step:
(iii) spray coating the catalyst ink formulation onto a membrane.

20. (canceled)

21. A process of forming a catalyst coated membrane, comprising the steps:
(A) providing a catalyst ink formulation comprising a catalyst, an ionomer and water that has been subjected to ball milling followed by ultrasonication; and
(B) spray coating the catalyst ink formulation onto a membrane.

22. (canceled)

23. The process according to claim 21, further comprising a step:
(C) incorporating the catalyst coated membrane into a fuel cell.
